(19) United States
(12) Patent Application Publication
(10) Pub. No.: US 2026/0045477 A1
(43) Pub. Date: Feb. 12, 2026

(54) METHOD OF MANUFACTURING ENERGY STORAGE APPARATUS

(71) Applicant: GS Yuasa International Ltd., Kyoto-shi (JP)

(72) Inventors: Kazuya OKABE, Kyoto-shi (JP); Ryoichi OKUYAMA, Kyoto-shi (JP)

(21) Appl. No.: 19/360,040

(22) Filed: Oct. 16, 2025

Related U.S. Application Data
(63) Continuation of application No. PCT/JP2024/006288, filed on Feb. 21, 2024.

(30) Foreign Application Priority Data
Apr. 18, 2023 (JP) 2023-067999

(51) Int. Cl. H01M 4/04; H01M 4/02

(52) U.S. Cl. CPC H01M 4/0435; H01M 2004/021

(57) ABSTRACT

A method of manufacturing an energy storage apparatus includes locating a first active material layer of a positive electrode active material layer and a negative electrode active material layer on a current collector foil and pressing the first active material layer, and locating a second active material layer of the positive electrode active material layer and the negative electrode active material layer on the current collector foil and pressing the second active material layer together with the first active material layer. In the locating and pressing the first active material layer the first active material layer, which is more easily crushed than the second active material layer, is located on the current collector foil, and is pressed at a pressure equal to the pressure at which the second active material layer is pressed, or at a pressure higher than the pressure at which the second active material layer is pressed.

### CROSS REFERENCE TO RELATED APPLICATIONS

This application claims the benefit of priority to Japanese Patent Application No. 2023-067999 filed on Apr. 18, 2023 and is a Continuation application of PCT Application No. PCT/JP2024/006288 filed on Feb. 21, 2024. The entire contents of each application are hereby incorporated herein by reference.

### BACKGROUND OF THE INVENTION

### 1. Field of the Invention

The present invention relates to methods of manufacturing energy storage apparatuses.

### 2. Description of the Related Art

Conventionally, there has been known a method of manufacturing an energy storage apparatus including an electrode unit in which active material layers (a positive electrode active material layer and a negative electrode active material layer) are formed on both surfaces of a current collector foil. JP2006-128039 A discloses a method of manufacturing a bipolar battery electrode using a double-side coated electrode for a bipolar battery in which an active material that is not easily crushed is first applied and pressed on a first surface of a current collector, and an active material that is easily crushed is thereafter applied and pressed on a remaining surface.

### SUMMARY OF THE INVENTION

In the above-described conventional method of manufacturing an energy storage apparatus, as disclosed in JP2006-128039 A, when an active material that is not easily crushed is first applied to one surface of the current collector foil and pressed, a strain is likely to be produced in the current collector foil, and the current collector foil is likely to have pinholes. In particular, in JP2006-128039 A, a pressing pressure for the active material that is not easily crushed is made to be large (refer to paragraph and the like of the specification). Therefore, a strain is likely to be produced in the current collector foil due to a high pressing pressure applied in pressing the active material that is not easily crushed, and the current collector foil may be damaged, such as having pinholes in the current collector foil.

Example embodiments of the present invention provide methods of manufacturing energy storage apparatuses in each of which damage to a current collector foil is reduced or prevented.

A method of manufacturing an energy storage apparatus according to an example embodiment of the present invention pertains to a method of manufacturing an energy storage apparatus including a plurality of electrode units stacked in a stacking direction and each including at least a current collector foil, a positive electrode active material layer on a first surface of the current collector foil, and a negative electrode active material layer on a second surface of the current collector foil, the method including locating a first active material layer of the positive electrode active material layer and the negative electrode active material layer on the current collector foil and pressing the first active material layer, and after the locating and pressing the first active material layer, locating a second active material layer of the positive electrode active material layer and the negative electrode active material layer on the current collector foil and pressing the second active material layer together with the first active material layer, wherein in the locating and pressing the first active material layer, the first active material layer, which is more easily crushed than the second active material layer, is located on the current collector foil, and is pressed at a pressure equal to the pressure at which the second active material layer is pressed, or at a pressure higher than the pressure at which the second active material layer is pressed.

According to methods of manufacturing energy storage apparatuses of example embodiments of the present invention, damage to the current collector foil is reduced or prevented.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating an outer appearance of an energy storage apparatus according to an example embodiment of the present invention.

FIG. 2 is a cross-sectional view illustrating an internal configuration of an energy storage apparatus according to an example embodiment of the present invention.

FIGS. 3A and 3B represent a perspective view and a cross-sectional view illustrating a configuration of an electrode unit of an energy storage apparatus according to an example embodiment of the present invention.

FIG. 4 is a flowchart showing a manufacturing process in a method of manufacturing an energy storage apparatus according to an example embodiment of the present invention.

FIGS. 5A and 5B represent cross-sectional views illustrating a manufacturing process in a method of manufacturing an energy storage apparatus according to an example embodiment of the present invention.

FIG. 6 is a cross-sectional view illustrating a configuration of an energy storage pack.

FIG. 7 is a cross-sectional view illustrating another configuration of the energy storage pack.

### DETAILED DESCRIPTION OF THE EXAMPLE EMBODIMENTS

(1) A method of manufacturing an energy storage apparatus according to an example embodiment of the present invention pertains to a method of manufacturing an energy storage apparatus including a plurality of electrode units stacked in a stacking direction and each including at least a current collector foil, a positive electrode active material layer on a first surface of the current collector foil, and a negative electrode active material layer on a second surface of the current collector foil, the method including locating a first active material layer of the positive electrode active material layer and the negative electrode active material layer on the current collector foil and pressing the first active material layer, and after the locating and pressing the first active material layer, locating a second active material layer of the positive electrode active material layer and the negative electrode active material layer on the current collector foil and pressing the second active material layer together with the first active material layer, wherein in the locating and pressing the first active material layer, the first active material layer, which is more easily crushed than the second active material layer, is located on the current collector foil, and is pressed at a pressure equal to the pressure at which the second active material layer is pressed, or at a pressure higher than the pressure at which the second active material layer is pressed.

According to a method of manufacturing an energy storage apparatus, in the locating and pressing the first active material layer, the first active material layer that is more easily crushed than the second active material layer is located on the current collector foil, and is pressed at a pressure equal to the pressure at which the second active material layer is pressed, or at a pressure higher than the pressure at which the second active material layer is pressed. As described above, by using an easily crushable active material layer for the active material layer to be pressed at a relatively large pressure in the locating and pressing the first active material layer, a strain is less likely to be produced in the current collector foil. Consequently, the current collector foil is less likely to have pinholes. In the locating and pressing the second active material layer, by pressing the active material layer which is not easily crushed at a relatively small pressure, it is possible to prevent a strain from being produced in the current collector foil. Consequently, it is possible to reduce or prevent formation of pinholes in the current collector foil. As a consequence, it is possible to reduce or prevent damage to the current collector foil.

(2) In the method of manufacturing the energy storage apparatus according to (1) described above, in the locating and pressing the first active material layer, the first active material layer having a higher porosity than the second active material layer may be located on the current collector foil and pressed.

By this feature, in the locating and pressing the first active material layer, as the active material layer whose porosity is high before the press is located on the current collector foil, the active material layer which is easily crushed can be located on the current collector foil.

(3) In the method of manufacturing the energy storage apparatus according to (1) or (2) described above, in the locating and pressing the first active material layer, the first active material layer, which is larger in size than the second active material layer when viewed from the stacking direction, may be pressed.

If the first active material layer which is larger in size is located on the current collector foil after the second active material layer which is smaller in size has been located on the current collector foil and pressed, there is no receiving portion in the second active material layer for a portion of the first active material layer protruding from the second active material layer. In this case, when the first active material layer is located on the current collector foil, the current collector foil may be pushed into a portion which does not have the receiving portion of the second active material layer due to the pressure applied to a portion where the second active material layer is located in locating the second active material layer. As a consequence, the first active material layer may be located abundantly at such a portion. As can be seen, the amount of the first active material layer at the protruding portion may not be stable. When the first active material layer is pressed, since the second active material layer is not opposed to the protruding portion, the protruding portion cannot be sufficiently pressed, and the protruding portion may become thick. As a result, the thickness of the protruding portion of the first active material layer is increased, and due to the increased thickness portion of the first active material layer, when the electrode units are stacked, such problems that a large pressure which presses the current collector foil is applied, or stacking becomes difficult due to creases being formed in the current collector foil may occur. In the protruding portion which cannot be sufficiently pressed, a binding force for binding with the current collector foil is not sufficiently increased, and the active material may easily fall off. Therefore, in the locating and pressing the first active material layer, the first active material layer which is larger in size is pressed prior to pressing the second active material layer which is smaller in size. As a consequence, it is possible to prevent the above-described problems from occurring.

(4) In the method of manufacturing the energy storage apparatus according to any one of (1) to (3) described above, in the locating and pressing the first active material layer, the negative electrode active material layer may be pressed as the first active material layer, and in the locating and pressing the second active material layer, the positive electrode active material layer may be pressed as the second active material layer.

By this feature, since the negative electrode active material layer is generally larger in size than the positive electrode active material layer, the negative electrode active material layer is pressed prior to the positive electrode active material layer in the first press step. As a consequence, it is possible to reduce or prevent an increase in the thickness of the portion of the negative electrode active material layer which protrudes from the positive electrode active material layer. Therefore, it is possible to prevent the aforementioned problems caused by the increase in the thickness of the protruding portion from occurring.

In the following, energy storage apparatuses and methods of manufacturing the same according to example embodiments (including modifications thereof) will be described with reference to the drawings. Each of the example embodiments described below illustrates either a comprehensive or specific example. A numerical value, a shape, a material, an element, a position of arrangement and a form of connection of the elements, manufacturing processes, an order of the manufacturing processes, and the like, which are described in the following example embodiments, are merely examples, and are not intended to limit the present invention. In each of the drawings, dimensions and the like are not strictly illustrated. In the drawings, same or similar elements are assigned an identical reference numeral.

In the following description and the drawings, a longitudinal direction of an energy storage apparatus, or in other words, a direction in which a pair of short side surfaces of the energy storage apparatus are opposed to each other, is defined as an X-axis direction. A direction in which a pair of long side surfaces of the energy storage apparatus are opposed to each other is defined as a Y-axis direction. A thickness direction of the energy storage apparatus, a stacking direction of a plurality of electrode units, a stacking direction of a current collector foil and an active material layer, an arrangement direction of a pair of end members, or in other words, an up-down direction, is defined as a Z-axis direction. The X-axis direction, the Y-axis direction, and the Z-axis direction are directions intersecting each other (orthogonal to each other in the present example embodiment). Although there may be a case where the Z-axis direction does not conform to the up-down direction depending on a use mode, the Z-axis direction is described as the up-down direction in the following for convenience of description.

In the following description, an X-axis positive direction indicates a direction of an arrow in the X-axis, and an X-axis negative direction indicates a direction opposite to the X-axis positive direction. When the direction is simply referred to as the X-axis direction, it indicates both of or one of the X-axis positive direction and the X-axis negative direction. The same applies to the Y-axis direction and the Z-axis direction. Expressions indicating relative directions or postures, such as parallel and orthogonal, include cases where the directions or postures are not parallel or orthogonal in a strict sense. Two directions being parallel to each other means not only that the two directions are completely parallel to each other, but also that the two directions are substantially parallel to each other, in other words, a difference by several percent or so, for example, is included in the scope. In the following description, when the expression “insulating” is used, “insulating” is intended as “electrical insulation”.

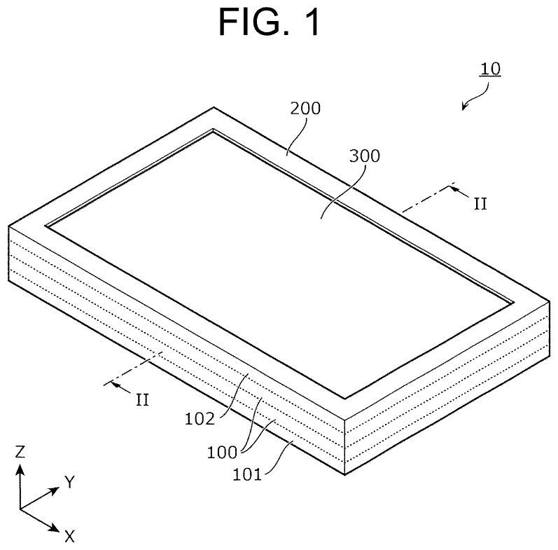

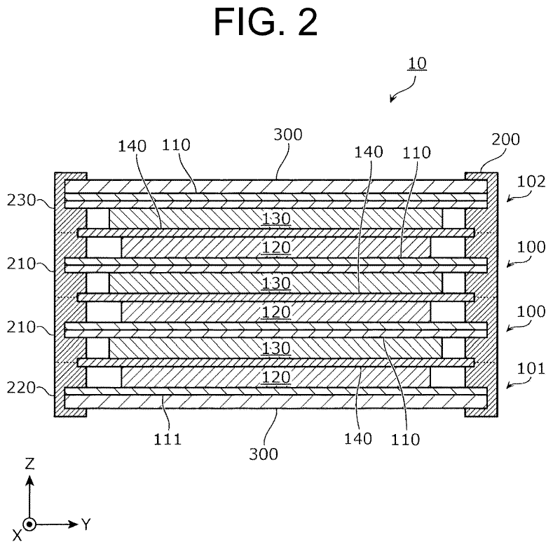

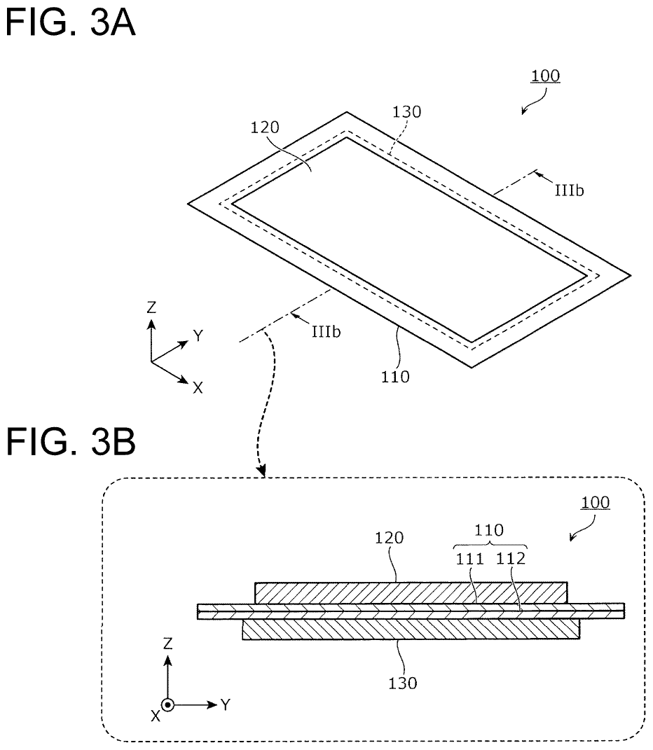

First, a general description of an energy storage apparatus 10 in the present example embodiment will be given. FIG. 1 is a perspective view illustrating an outer appearance of the energy storage apparatus 10 according to the present example embodiment. FIG. 2 is a cross-sectional view illustrating an internal configuration of the energy storage e apparatus 10 according to the present example embodiment. Specifically, FIG. 2 is a cross-sectional view of the energy storage apparatus 10 of FIG. 1 taken along a YZ plane passing through line II-II. FIG. 2 illustrates each of the elements of the energy storage apparatus 10. FIGS. 3A and 3B represent a perspective view and a cross-sectional view illustrating a configuration of an electrode unit 100 of the energy storage apparatus 10 according to the present example embodiment. Specifically, illustration FIG. 3A is a perspective view showing an outer appearance of the electrode unit 100. Illustration FIG. 3B is a cross-sectional view illustrating a configuration of the electrode unit 100 in illustration FIG. 3A taken along a YZ plane passing through line IIIb-IIIb. For the convenience of description, a sealing portion 210 of the electrode unit 100 is omitted from illustration in FIGS. 3A and 3B.

The energy storage apparatus 10 is an apparatus which can be charged with electricity from outside and can discharge electricity to the outside. The energy storage apparatus 10 of the present example embodiment has a substantially rectangular parallelepiped shape. Specifically, the energy storage apparatus 10 is a bipolar battery. The energy storage apparatus 10 is used as a battery for driving or starting an engine of movable bodies such as automobiles, motorcycles, watercrafts, ships, snowmobiles, agricultural machines, construction machines, automatic guided vehicles (AGV) or railway vehicles for electric railway. As the above-mentioned automobiles, electric vehicles (EVs), hybrid electric vehicles (HEVs), plug-in hybrid electric vehicles (PHEVs), and fossil fuel (gasoline, light oil, liquefied natural gas, or the like) automobiles are exemplified. As the above-mentioned railway vehicles for electric railway, trains, monorails, linear induction motor trains, and hybrid trains provided with both a diesel engine and an electric motor are exemplified. The energy storage apparatus 10 can also be used as a stationary battery or the like for home or business, etc.

As illustrated in FIGS. 1 and 2, the energy storage apparatus 10 is provided with a plurality of electrode units 100, end units 101 and 102, a plurality of separators 140, and a pair of end members 300. Each of the plurality of electrode units 100, the end unit 101, and the end unit 102 is a plate-shaped portion having a rectangular shape in a plan view, and is stacked in the Z-axis direction. The plan view in the present example embodiment view refers to a view in which the above elements are seen from the stacking direction (the Z-axis direction). A direction (the Z-axis direction) in which the plurality of electrode units 100, the end unit 101, and the end unit 102 are stacked is also referred to as the stacking direction. The separator 140 is disposed between the plurality of electrode units 100 and between the electrode unit 100 and each of the end units 101 and 102. The pair of end members 300 are disposed on both sides of the plurality of electrode units 100 and the end units 101 and 102 in the stacking direction (the Z-axis direction). In the present example embodiment, although two electrode units 100 are stacked in the stacking direction between the end unit 101 and the end unit 102, the number of electrode units 100 to be stacked is not particularly limited. The shapes of the electrode unit 100, the end unit 101, the end unit 102, and the like, in a plan view are also not particularly limited.

In the following, a configuration of the electrode unit 100 will be described in detail also with reference to FIGS. 3A and 3B. The electrode unit 100 is a single unit in which an active material layer is formed on both sides of one sheet of current collector foil. Each of the plurality of electrode units 100 includes at least a current collector foil 110, a positive electrode active material layer 120 formed on a first surface of the current collector foil 110, a negative electrode active material layer 130 formed on a second surface of the current collector foil 110, and the sealing portion 210. In the present example embodiment, a thickness (thickness in the stacking direction) of the electrode unit 100 is about 135 μm to about 190 μm, for example.

The current collector foil 110 is a plate-shaped member having a rectangular shape in a plan view. The current collector foil 110 is a metal foil. As illustrated in FIGS. 3A and 3B, the current collector foil 110 includes two metal layers 111 and 112 located in the stacking direction (the Z-axis direction). The metal layers 111 and 112 are plate-shaped portions having the same size and the same shape in a plan view. In the following, of the metal layers 111 and 112, the metal layer 111 on which the positive electrode active material layer 120 is formed will also be referred to as a positive electrode metal layer 111, and the metal layer 112 on which the negative electrode active material layer 130 is formed will also be referred to as a negative electrode metal layer 112. The positive electrode metal layer 111 is the metal layer which is located in a Z-axis positive direction of the current collector foil 110, and the negative electrode metal layer 112 is the metal layer which is located in a Z-axis negative direction of the current collector foil 110. That is, the current collector foil 110 is formed by stacking the positive electrode metal layer 111 and the negative electrode metal layer 112 in the stacking direction in a state in which the positive electrode metal layer 111 and the negative electrode metal layer 112 are connected to each other (brought into contact with each other or bonded to each other). Of the positive electrode metal layer 111 and the negative electrode metal layer 112, one of these metal layers may be a metal foil, and an other one of the metal layers may be a plating layer plated on the metal foil. Alternatively, both the positive electrode metal layer 111 and the negative electrode metal layer 112 may be metal foils. When both of the positive electrode metal layer 111 and the negative electrode metal layer 112 are metal foils, the current collector foil 110 may be a clad material or the like formed by bonding two metal foils to each other, or alternatively, include two metal foils in a state in which the two metal foils are connected to (brought into contact with) each other without being bonded.

As a material of the positive electrode metal layer 111, a metal such as aluminum, titanium, tantalum, or stainless steel, or an alloy thereof is used. Among the above materials, aluminum or an aluminum alloy is preferable as the material of the positive electrode metal layer 111 in view of a balance among potential resistance, high conductivity, and the cost. As a form of the positive electrode metal layer 111, while a plating layer may be used, foil is preferable in terms of processability and the cost. That is, aluminum foil is preferable as the positive electrode metal layer 111. As a material of the negative electrode metal layer 112, a metal such as copper, nickel, stainless steel, or nickel-plated steel, or an alloy thereof is used, and among these materials, copper or a copper alloy should be preferably used. As the form of the negative electrode metal layer 112, a plating layer or a foil (copper foil) is given as an example, and examples of the copper foil include rolled copper foil and electrolytic copper foil. The thickness (thickness in the stacking direction) of the current collector foil 110 is about 20 μm to about 30 μm, for example. The thickness (thickness in the stacking direction) of the positive electrode metal layer 111 is about 5 μm to about 20 μm, and the thickness (thickness in the stacking direction) of the negative electrode metal layer 112 is about 5 μm to about 15 μm, for example.

The positive electrode active material layer 120 is an active material layer of a positive electrode formed on a first surface (a surface in the Z-axis positive direction) of the current collector foil 110. Specifically, the positive electrode active material layer 120 is formed on the positive electrode metal layer 111 (i.e., an outer surface (the surface in the Z-axis positive direction) of the positive electrode metal layer 111). The positive electrode active material layer 120 is formed in a rectangular shape that is smaller in size than the positive electrode metal layer 111 in a plan view according to the shape of the positive electrode metal layer 111. Being small in size in a plan view means that an area of an XY plane is small. The same can be said of the following. The thickness (thickness in the stacking direction) of the positive electrode active material layer 120 is about 70 μm to about 100 μm, for example.

The positive electrode active material layer 120 contains a positive electrode active material, and if necessary, contains optional components such as a conductive agent, a binder, a thickener, and a filler. Examples of the positive electrode active material include layered lithium transition metal oxides such as LiM1O₂ (where M1 is one or more metallic elements selected from a group consisting of Li, Fe, Ni, Mn, Co, and the like), spinel-type lithium transition metal oxides such as LiM2₂O₄ (where M2 is one or more metallic elements selected from a group consisting of Li, Fe, Ni, Mn, Co, and the like), and polyanion compounds such as LiM₃PO₄, LiM₃SiO₄, and LiM₃BO₃ (where M3 is one or more metallic elements selected from a group consisting of Li, Fe, Ni, Mn, Co, and the like). As the positive electrode active material, one of these compounds may be used alone, or two or more of these compounds may be mixed and used. The conductive agent contained in the positive electrode active material layer 120 is not particularly limited as long as conductivity is exhibited. Examples of the conductive agent include carbon black, such as furnace black, acetylene black, and ketjen black, and natural or artificial graphite. Examples of the binder (a binding agent) include fluororesins (polytetrafluoroethylene (PTFE), polyvinylidene fluoride (PVDF), and the like), sulfonated EPDM, and styrene-butadiene rubber (SBR). Examples of the thickener include polysaccharide polymers such as carboxymethyl cellulose (CMC) and methyl cellulose.

The negative electrode active material layer 130 is an active material layer of a negative electrode formed on a second surface (a surface in the Z-axis negative direction) of the current collector foil 110. Specifically, the negative electrode active material layer 130 is formed on the negative electrode metal layer 112 (i.e., an outer surface (the surface in the Z-axis negative direction) of the negative electrode metal layer 112). The negative electrode active material layer 130 is formed in a rectangular shape that is smaller in size than the negative electrode metal layer 112 in a plan view according to the shape of the negative electrode metal layer 112. The negative electrode active material layer 130 is formed to be larger in size than the positive electrode active material layer 120 in a plan view. Being large in size in a plan view means that an area of the XY plane is large. The same can be said of the following. That is, the area of the XY plane of the negative electrode active material layer 130 is larger than that of the positive electrode active material layer 120. The thickness (thickness in the stacking direction) of the negative electrode active material layer 130 is about 45 μm to about 60 μm, for example.

The negative electrode active material layer 130 contains a negative electrode active material, and if necessary, contains optional components such as a conductive agent, a binder, a thickener, and a filler. As the optional components such as the conductive agent, the binder, the thickener, and the filler, components similar to those of the positive electrode active material layer 120 may be used. As the negative electrode active material, a material capable of occluding and releasing lithium ions is usually used. Examples of the negative electrode active material include metals or semimetals such as Si and Sn; metal oxides or semimetal oxides such as Si oxides and Sn oxides; and carbon materials such as graphite and non-graphite carbon (easily-graphitizable carbon or non-graphitizable carbon).

The sealing portion 210 is a portion disposed around the positive electrode active material layer 120 or the negative electrode active material layer 130. In the present example embodiment, the sealing portion 210 is an annular portion disposed around the positive electrode active material layer 120 and the negative electrode active material layer 130 over the entire periphery of the positive electrode active material layer 120 and the negative electrode active material layer 130. Specifically, the sealing portion 210 is formed in a square annular shape along an outer peripheral portion of the current collector foil 110 so as to cover the outer peripheral portion of the current collector foil 110. The sealing portion 210 is formed of an insulating member constituted of polycarbonate (PC), polypropylene (PP), polyethylene (PE), polystyrene (PS), polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), polyamide (PA), or ABS resin, or a composite material thereof.

The sealing portions 210 of two adjacently located electrode units 100 are connected to each other. The sealing portions 210 may be integrally and continuously formed to be connected to each other, or the sealing portions 210 may be bonded to each other by heat sealing (thermal welding), ultrasonic welding, laser welding, or an adhesive, etc., to be connected to each other. Thus, the sealing portion 210 is disposed around the positive electrode active material layer 120 of one electrode unit 100 of the two electrode units 100 and the negative electrode active material layer 130 of the other one of the two electrode units 100, and the sealing portion 210 is provided between the current collector foils 110 of these two electrode units 100. That is, the sealing portion 210 is continuously provided between the current collector foils 110 of the two electrode units 100, and space between the current collector foils 110 is sealed.

An electrolyte layer (not shown) is formed on an inner side of the sealing portion 210 of each of the plurality of electrode units 100. In the present example embodiment, while the electrolyte layer is a nonaqueous liquid electrolyte (electrolytic solution), the electrolyte layer may be a solid-form electrolyte (solid electrolyte), a gel electrolyte, or the like. As these electrolytes, known electrolytes can be used as appropriate. As the electrolytic solution (nonaqueous electrolyte), an electrolytic solution formed by dissolving an electrolyte salt in a nonaqueous solvent can be used. Examples of the nonaqueous solvent include cyclic carbonates such as ethylene carbonate (EC) and propylene carbonate (PC), and chain carbonates such as diethyl carbonate (DEC), dimethyl carbonate (DMC), and ethyl methyl carbonate (EMC). As the electrolyte salt, a lithium salt is preferable. Examples of the lithium salt mentioned above include inorganic lithium salts such as LiPF₆, LiPO₂F₂, LiBF₄, LiClO₄, LiN(SO₂F)₂, and LiN(SO₂CF₃)₂.

Next, a configuration of the end units 101 and 102 will be described in detail. The end unit 101 is disposed at an end portion of the plurality of electrode units 100 in the Z-axis negative direction. The end unit 102 is disposed at an end portion of the plurality of electrode units 100 in the Z-axis positive direction. The end units 101 and 102 are portions which sandwich the plurality of electrode units 100 in the Z-axis direction.

The end unit 101 includes at least the positive electrode metal layer 111, the positive electrode active material layer 120 formed on a surface of the positive electrode metal layer 111 in the Z-axis positive direction, and a sealing portion 220. The positive electrode metal layer 111 and the positive electrode active material layer 120 included in the end unit 101 have configurations similar to those of the positive electrode metal layer 111 and the positive electrode active material layer 120 of the current collector foil 110 included in the electrode unit 100 described above.

The sealing portion 220 is a portion disposed around the positive electrode active material layer 120. In the present example embodiment, the sealing portion 220 is an annular portion disposed around the positive electrode active material layer 120 over the entire periphery of the positive electrode active material layer 120. Specifically, the sealing portion 220 is formed in a square annular shape along an outer peripheral portion of the positive electrode metal layer 111 and the end member 300 so as to cover the outer peripheral portion of the positive electrode metal layer 111 and the end member 300. The sealing portion 220 is formed of the same material as that of the sealing portion 210 of the electrode unit 100.

The sealing portion 220 and the sealing portion 210 of the electrode unit 100 which is adjacent to the end unit 101 are connected to each other. Since the connection of the sealing portion 220 and the sealing portion 210 is the same as the above-described connection of the sealing portions 210 to each other, detailed description thereof will be omitted. Thus, space between the positive electrode metal layer 111 of the end unit 101 and the current collector foil 110 of the electrode unit 100 is sealed. The electrolyte layer described above (not shown) is formed on the inner side of the sealing portion 220.

The end unit 102 includes at least the current collector foil 110, the negative electrode active material layer 130 disposed on a surface of the current collector foil 110 in the Z-axis negative direction, and a sealing portion 230. The current collector foil 110 and the negative electrode active material layer 130 included in the end unit 102 have configurations similar to those of the current collector foil 110 and the negative electrode active material layer 130 included in the electrode unit 100 described above.

The sealing portion 230 is a portion disposed around the negative electrode active material layer 130. In the present example embodiment, the sealing portion 230 is an annular portion disposed around the negative electrode active material layer 130 over the entire periphery of the negative electrode active material layer 130. Specifically, the sealing portion 230 is formed in a square annular shape along an outer peripheral portion of the current collector foil 110 and the end member 300 so as to cover the outer peripheral portion of the current collector foil 110 and the end member 300. The sealing portion 230 is formed of the same material as that of the sealing portion 210 of the electrode unit 100.

The sealing portion 230 and the sealing portion 210 of the electrode unit 100 which is adjacent to the end unit 102 are connected to each other. Since the connection of the sealing portion 230 and the sealing portion 210 is the same as the above-described connection of the sealing portions 210 to each other, detailed description thereof will be omitted. Thus, space between the current collector foil 110 of the end unit 102 and the current collector foil 110 of the electrode unit 100 is sealed. The electrolyte layer described above (not shown) is formed on the inner side of the sealing portion 230.

In this way, the sealing portions 210, 220, and 230 are connected to each other to constitute a sealing member 200. The sealing member 200 is a tubular (quadrangular tubular) member which is disposed so as to surround the entire periphery of all of the positive electrode metal layer 111, the negative electrode metal layer 112, the positive electrode active material layer 120, the negative electrode active material layer 130, the separator 140, and the end member 300, and seals between these elements and the outside.

The separator 140 is a microporous sheet made of resin. The separator 140 is disposed between the electrode units 100, between the end unit 101 and the electrode unit 100, and between the end unit 102 and the electrode unit 100. Specifically, the separator 140 is disposed between the positive electrode active material layer 120 and the negative electrode active material layer 130. As a material of the separator 140, for example, woven fabric, nonwoven fabric, a porous resin film, or the like, is used. Among the above materials, a porous resin film is preferable. As the main component of the porous resin film, polyolefins such as polyethylene and polypropylene are preferable from the standpoint of the strength. The separator 140 may be a multilayered film including layers containing fillers formed on the surfaces of such porous resin films. The separator 140 is formed in a rectangular shape that is larger in size than the negative electrode active material layer 130 in a plan view. In the present example embodiment, although the size of the separator 140 is smaller than that of the current collector foil 110 in a plan view, the separator 140 may be larger in size than the current collector foil 110 in a plan view. The thickness (thickness in the stacking direction) of the separator 140 is about 15 μm to about 20 μm, for example.

The end member 300 is a member disposed closer to an end portion of the energy storage apparatus 10 in the stacking direction (the Z-axis direction) than the plurality of electrode units 100. In the present example embodiment, the paired end members 300 are disposed at the farthest end portion in the Z-axis negative direction of the energy storage apparatus 10 and the farthest end portion in the Z-axis positive direction of the same, respectively. The paired end members 300 are each connected to (the positive electrode metal layer 111 included in) the end units 101 and 102. Thus, the paired end members 300 sandwich the plurality of electrode units 100 and the end units 101 and 102, and the like, which are positioned between the end members 300 from both sides in the stacking direction (the Z-axis direction). Each of the end members 300 is a flat-shaped member (an end plate). The end member 300 is electrically connected to another end member 300 of another energy storage apparatus 10 via another conductive member (a bus bar or a cooling plate, etc., not illustrated). The end member 300 is formed of a conductive member made of metal such as aluminum, an aluminum alloy, copper, a copper alloy, or nickel, or a combination thereof, or a member having conductivity other than metal, for example. Since the end member 300 is connected to the positive electrode metal layer 111, the end member 300 should preferably be formed of the same material as that of the positive electrode metal layer 111 such as aluminum. The thickness (thickness in the stacking direction) of the end member 300 is about 0.5 mm to about 3 mm, for example. The energy storage apparatus 10 may include another conductive member on an outer side of the end member 300 (i.e., on the outer side in the Z-axis direction).

In the above-described configuration, the separator 140, the positive electrode active material layer 120 and the negative electrode active material layer 130 sandwiching the separator 140 in the Z-axis direction, and the positive electrode metal layer 111 and the negative electrode metal layer 112 sandwiching the aforementioned elements in the Z-axis direction may be referred to as one energy storage device. In this case, it can also be said that the energy storage apparatus 10 is a group of energy storage devices having a configuration in which a plurality of energy storage devices stacked in the Z-axis direction are sandwiched between the pair of end members 300 in the Z-axis direction, and a periphery of these elements is surrounded by the sealing member 200.

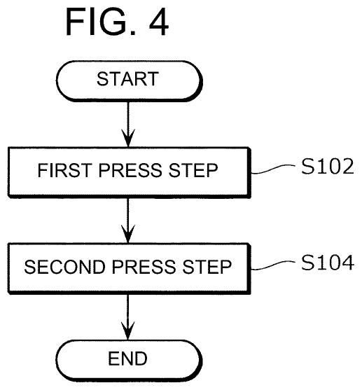

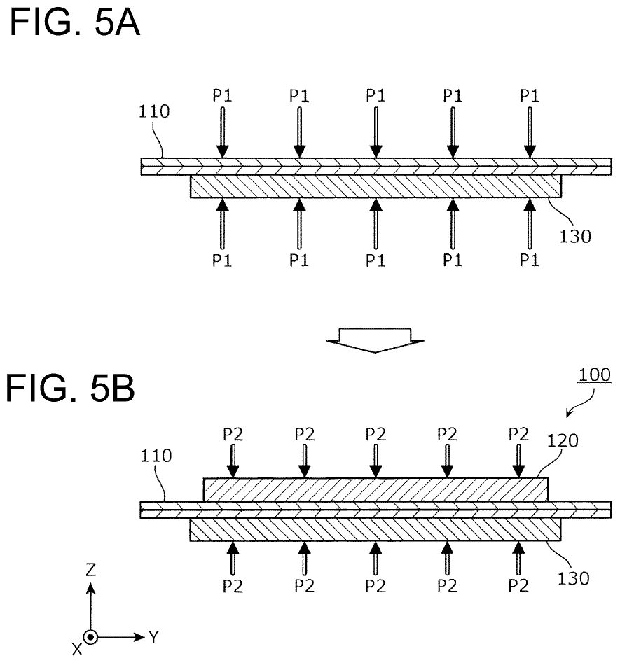

Next, a method of manufacturing the energy storage apparatus 10 will be described. FIG. 4 is a flowchart showing a manufacturing process in a method of manufacturing the energy storage apparatus 10 according to the present example embodiment. Specifically, FIG. 4 is a flowchart showing a manufacturing process in a method of manufacturing the electrode unit 100 in the method of manufacturing the energy storage apparatus 10. FIGS. 5A and 5B represent cross-sectional views illustrating the manufacturing process in the method of manufacturing the energy storage apparatus 10 according to the present example embodiment. Specifically, illustration FIG. 5A shows a first press step in the method of manufacturing the energy storage apparatus 10 (the method of manufacturing the electrode unit 100), and illustration FIG. 5B shows a second press step in the method of manufacturing the energy storage apparatus 10 (the method of manufacturing the electrode unit 100). FIGS. 5A and 5B are views corresponding to illustration FIG. 3B, and the sealing portion 210 of the electrode unit 100 is omitted from illustration in FIGS. 5A and 5B. In the first press step and the second press step, the sealing portion 210 may or may not be formed on the electrode unit 100. In the present example embodiment, the sealing portion 210 is located around the positive electrode active material layer 120 and the negative electrode active material layer 130 after the second press step.

As indicated in FIG. 4, first, the first press step of preparing the current collector foil 110, and locating an active material layer on a first surface of the current collector foil 110 and pressing the active material layer is performed (S102). In the first press step, a first active material layer of the positive electrode active material layer 120 and the negative electrode active material layer 130 is located on the current collector foil 110 and pressed. In the present example embodiment, the first active material layer corresponds to the negative electrode active material layer 130. That is, in the first press step, the negative electrode active material layer 130 is pressed as the first active material layer. Specifically, as illustrated in FIGS. 5A and 5B, in the first press step, the negative electrode active material layer 130 is located on a surface of the current collector foil 110 in the Z-axis negative direction, and the negative electrode active material layer 130 is pressed at a pressure P1. The pressure P1 and a pressure P2 to be described later refer to the pressure of a press linear pressure. In illustration FIG. 5A, instead of pressing the negative electrode active material layer 130 in a state in which the negative electrode active material layer 130 is located on the surface of the current collector foil 110 in the Z-axis negative direction, the pressing may be performed in such a way that the current collector foil 110 is located to be turned upside down, then the negative electrode active material layer 130 is placed on a surface of the current collector foil 110 in the Z-axis positive direction and pressed, and then the current collector foil 110 is turned upside down so that the position is returned to that of illustration FIG. 5A.

Next, after the first press step, the second press step of locating an active material layer on a second surface of the current collector foil 110 and pressing the active material layer is performed (S104). In the second press step, after the first press step, an other active material layer of the positive electrode active material layer 120 and the negative electrode active material layer 130 is located on the current collector foil 110 and the second active material layer is pressed together with the first active material layer. In the present example embodiment, the second active material layer corresponds to the positive electrode active material layer 120. That is, in the second press step, the positive electrode active material layer 120 is pressed as the second active material layer. Specifically, as illustrated in FIGS. 5A and 5B, in the second press step, the positive electrode active material layer 120 is located on the surface of the current collector foil 110 in the Z-axis positive direction, and the positive electrode active material layer 120 is pressed at the pressure P2 together with the negative electrode active material layer 130.

As described above, since the first active material layer is the negative electrode active material layer 130 and the second active material layer is the positive electrode active material layer 120, the first active material layer (the negative electrode active material layer 130) is larger in size than the second active material layer (the positive electrode active material layer 120) when viewed from the stacking direction (the Z-axis direction). Therefore, in the first press step, the first active material layer whose size is larger than that of the second active material layer when viewed from the stacking direction is pressed.

In the present example embodiment, the first active material layer (the negative electrode active material layer 130) is more easily crushed than the second active material layer (the positive electrode active material layer 120). The pressure P1 in the first press step is equal to the pressure P2 in the second press step or higher than the pressure P2. For this reason, in the first press step, the first active material layer that is more easily crushed than the second active material layer is located on the current collector foil 110, and is pressed at a pressure equal to the pressure at which the second active material layer is pressed in the second press step, or at a pressure higher than the pressure of the second press step. Specifically, in the first press step, the negative electrode active material layer 130 that is more easily crushed than the positive electrode active material layer 120 is located on the current collector foil 110, and is pressed at the pressure P1 equal to the pressure P2 at which the positive electrode active material layer 120 is pressed in the second press step or higher than the pressure P2.

The definition of “easily crushed” is as described below. A crushability level can be defined by the press linear pressure which is applied to form the active material layer at the same void ratio. The press linear pressure means a value obtained by dividing a load to be applied by a press by a width of the active material layer which comes into contact with a press roll. When the press linear pressure that is applied to form the active material layer at the same void ratio is large, it means that the active material layer is not easily crushed, and when the press linear pressure is small, it means that the active material layer is easily crushed. In designing the energy storage apparatus 10, the void ratios of the active material layers are respectively optimized. Therefore, the void ratios are not necessarily the same and may be different from each other. That is, to locate the negative electrode active material layer 130 which is easily crushed (to locate the positive electrode active material layer 120 which is not easily crushed) is to locate the active material layers in the following two conditions. The first condition is to locate such an active material layer that the linear pressure required for the press to form the negative electrode active material layer 130 at the void ratio of the negative electrode active material layer 130 is smaller than the linear pressure required for the press to form the positive electrode active material layer 120 at the void ratio of the negative electrode active material layer 130. The second condition is to locate such an active material layer that the linear pressure required for the press to form the positive electrode active material layer 120 at the void ratio of the positive electrode active material layer 120 is greater than the linear pressure required for the press to form the negative electrode active material layer 130 at the void ratio of the positive electrode active material layer 120.

The negative electrode active material layer 130, which is relatively easily crushed, should preferably contain a negative electrode active material in which the amount of a carbon material having a small particle diameter is greater than that of a carbon material having a large particle diameter. The positive electrode active material layer 120, which is relatively not easily crushed, should preferably contain a positive electrode active material such as aggregated particles having a large particle diameter. Preferably, the pressure P1 in the first press step should be 350 kg/cm or more and 600 kg/cm or less, and more preferably, 400 kg/cm or more and 500 kg/cm or less. Preferably, the pressure P2 in the second press step should be 300 kg/cm or more and 500 kg/cm or less, and more preferably, 300 kg/cm or more and 400 kg/cm or less. Preferably, a difference between the pressure P1 in the first press step and the pressure P2 in the second press step should be 50 kg/cm or more and 100 kg/cm or less. The active material layers (the positive electrode active material layer 120 and the negative electrode active material layer 130) are pressed by being sandwiched between an upper press roll and a lower press roll in which directions of the rotation axes are aligned. The upper press roll and the lower press roll have a circular shape when viewed from the direction of the rotation axis, and a pressure is linearly (one dimensionally) applied to the active material layer. The upper press roll and the lower press roll may apply a load to the active material layer by using a hydraulic cylinder. The load (kg) applied to the active material layer by the press is a value obtained by subtracting a load (kg) of lifting the upper press roll from a total load (kg), which is the sum of a load (kg) of pressing the upper press roll against the active material layer while the lower press roll is fixed and a load (kg) of the upper press roll itself. The press linear pressure (pressure, kg/m) applied to the active material layer can be calculated by dividing the load (kg) applied to the active material layer by the length (m) of the active material layer in a direction in which the press roll extends (i.e., an axial direction of the press roll).

In the present example embodiment, the first active material layer (the negative electrode active material layer 130) has a porosity higher than that of the second active material layer (the positive electrode active material layer 120). Thus, the first active material layer (the negative electrode active material layer 130) is more easily crushed than the second active material layer (the positive electrode active material layer 120). That is, in the first press step, the first active material layer having a higher porosity than the second active material layer is located on the current collector foil 110 and pressed. Preferably, the porosity of the first active material layer (the negative electrode active material layer 130) before the press (before the first press step) should be 50% or more and 70% or less, and more preferably, 55% or more and 65% or less. Preferably, the porosity of the second active material layer (the positive electrode active material layer 120) before the press (before the second press step) should be 45% or more and 65% or less, and more preferably, 50% or more and 60% or less. A difference between the porosity of the active material layer pressed in the first press step and the porosity of the active material layer pressed in the second press step should preferably 5% or more and 10% or less.

The “porosity” of the positive electrode active material layer 120 and the negative electrode active material layer 130 is obtained by a calculation formula which is (1−V2/V1)×100, where V1 is the apparent volume (the volume including voids) of the positive electrode active material layer 120 (the negative electrode active material layer 130), and V2 is the sum of the actual volumes of the materials constituting the positive electrode active material layer 120 (the negative electrode active material layer 130). The sum V2 of the actual volumes of the materials constituting the positive electrode active material layer 120 (the negative electrode active material layer 130) is calculated from contents of the materials of the positive electrode active material layer 120 (the negative electrode active material layer 130) and true densities of the materials.

As described above, the method of manufacturing the energy storage apparatus 10 (the method of manufacturing the electrode unit 100) includes the first press step and the second press step. After the second press step (after the electrode units 100 have been manufactured), the plurality of electrode units 100 and the end units 101 and 102 are stacked in the stacking direction with the separators 140 interposed therebetween, and are then sandwiched between the pair of end members 300. The energy storage apparatus 10 is manufactured in this way.

As described above, with the method of manufacturing the energy storage apparatus 10 according to the example embodiment of the present invention, in the first press step, the first active material layer (the negative electrode active material layer 130) that is more easily crushed than the second active material layer (the positive electrode active material layer 120) is located on the current collector foil 110. In the first press step, pressing is performed at a pressure equal to the pressure at which the second active material layer (the positive electrode active material layer 120) is pressed in the second press step or higher than the pressure of the second press step. As described above, by using an easily crushable active material layer for the active material layer to be pressed at a relatively large pressure in the first press step, a strain is less likely to be produced in the current collector foil 110. Consequently, the current collector foil 110 is less likely to have pinholes. In the second press step, by pressing the active material layer which is not easily crushed at a relatively small pressure, it is possible to prevent a strain from being produced in the current collector foil 110. Consequently, it is possible to suppress formation of pinholes in the current collector foil 110. As a consequence, it is possible to suppress damage to the current collector foil 110.

In the current collector foil 110, when a pinhole is formed in the positive electrode metal layer 111 or the negative electrode metal layer 112, an electrolytic solution may penetrate through the pinhole to form a short circuit (a short circuit between the metal layer and the active material of the opposite polarity) by the electrolytic solution. In the pinhole of the positive electrode metal layer 111, the positive electrode active material layer 120 and the negative electrode metal layer 112 (Cu plating or the like) are short-circuited via the electrolytic solution, and further, a pinhole is also formed in Cu due to elution of the Cu, and ultimately, a short circuit between the positive electrode active material layer 120 and the negative electrode active material layer 130 occurs. In the pinhole of the negative electrode metal layer 112, the negative electrode active material layer 130 and the positive electrode metal layer 111 (Al foil or the like) are short-circuited via the electrolytic solution, and further, Li of the negative electrode penetrates into Al to form a Li/Al alloy and an alloy portion forms cracks due to expansion, and ultimately, a short circuit between the positive electrode active material layer 120 and the negative electrode active material layer 130 occurs. For this reason, by suppressing formation of pinholes in the current collector foil 110 (the positive electrode metal layer 111 or the negative electrode metal layer 112), it is possible to prevent a short circuit (liquid junction) from occurring inside the energy storage apparatus 10.

Furthermore, after pressing the first active material layer (the negative electrode active material layer 130), the second active material layer (the positive electrode active material layer 120) is pressed. By doing so, since each of the active material layers can be pressed at a more suitable pressure, the active material layers can be formed with a more suitable density. By pressing the first active material layer (the negative electrode active material layer 130) which is easily crushed at a relatively large pressure, the first active material layer (the negative electrode active material layer 130) can be compressed relatively greatly in terms of the thickness. Thus, the thickness of the energy storage apparatus 10 can be reduced, and the energy storage apparatus 10 having high-energy density can be obtained. By pressing the active material layers (the positive electrode active material layer 120 and the negative electrode active material layer 130) at a relatively small pressure in the second press step, it is possible to prevent the active material layer (the negative electrode active material layer 130) located in the first press step from being compressed excessively.

In the active material layer which is not easily crushed, such a change that the thickness thereof increases due to the active material layer being left unattended after the press may occur (a springback phenomenon). When the active material layer (the negative electrode active material layer 130) which is easily crushed is pressed in the first press step at a pressure greater than that in the second press step, the thickness thereof after the first press step is hard to change, and in the second press step, the second active material layer (the positive electrode active material layer 120) can be pressed with high accuracy in terms of the thickness. In the second press step, despite use of the active material layer that is not easily crushed, the active material layer for which a pressing pressure is low is selected and pressed. Therefore, springback is not likely to occur.

In the first press step, as the active material layer (the negative electrode active material layer 130) whose porosity is high before the press is located on the current collector foil 110, the active material layer (the negative electrode active material layer 130) which is easily crushed can be located on the current collector foil 110. The first active material layer whose porosity is high is easily deformed by the press. However, by performing the press before locating (applying (coating)) the second active material layer on the current collector foil 110, the second active material layer can be accurately located (applied (coated)) on the current collector foil 110 while suppressing deformation of the thickness.

If the first active material layer which is larger in size is located on the current collector foil 110 after the second active material layer which is smaller in size has been located on the current collector foil 110 and pressed, there is no receiving portion in the second active material layer for a portion of the first active material layer protruding from the second active material layer. In this case, when the first active material layer is located (applied (coated)) on the current collector foil 110, the current collector foil 110 may be pushed into a portion which does not have the receiving portion of the second active material layer due to the pressure applied to a portion where the second active material layer is located (applied portion (coated portion)) in locating (applying (coating)) the second active material layer. As a consequence, the first active material layer may be located (applied (coated)) abundantly at such a portion. As described above, the amount (application amount (coating amount)) of the first active material layer at the protruding portion may not be stable (since there is no receiving portion, a gap becomes large and the application amount (coating amount) is increased). When the first active material layer is pressed in the second press step, since the second active material layer is not opposed to the protruding portion, the protruding portion cannot be sufficiently pressed, and the protruding portion may become thick. As a result, the thickness of the protruding portion of the first active material layer is increased, and due to the increased thickness portion of the first active material layer, when the electrode units 100 are stacked, such problems that a large pressure which presses the current collector foil 110 is applied, or the stacking becomes difficult due to creases being formed in the current collector foil 110 may occur. In the protruding portion which cannot be sufficiently pressed, a binding force for binding with the current collector foil 110 is not sufficiently increased, and the active material may easily fall off. Therefore, in the first press step, the first active material layer which is larger in size is pressed prior to pressing the second active material layer which is smaller in size. As a consequence, it is possible to prevent the above-described problems from occurring.

Since the negative electrode active material layer 130 is generally larger in size than the positive electrode active material layer 120, the negative electrode active material layer 130 is pressed prior to the positive electrode active material layer 120 in the first press step. By this feature, it is possible to suppress an increase in the thickness of the portion of the negative electrode active material layer 130 which protrudes from the positive electrode active material layer 120. Therefore, it is possible to prevent the aforementioned problems caused by the increase in the thickness of the protruding portion from occurring.

The method of manufacturing the energy storage apparatus 10 according to the present example embodiment has been described above, but the present invention is not limited to the above-described example embodiments. The example embodiments disclosed herein are illustrative in all respects and not restrictive, and the scope of the present invention includes all modifications within the meaning and scope equivalent to the scope of the claims.

In the above-described example embodiment, it has been indicated that the current collector foil 110 is formed of a plurality of layers (two layers), which are the positive electrode metal layer 111 and the negative electrode metal layer 112. However, the current collector foil 110 may be formed of a single layer (one sheet of metal foil). That is, the current collector foil 110 may be formed of one sheet of stainless steel foil or the like, and the one sheet of stainless steel foil or the like may have the functions of the positive electrode metal layer and the negative electrode metal layer.

In the above-described example embodiment, in the first press step, the negative electrode active material layer 130 is located on the surface of the current collector foil 110 in the Z-axis negative direction and pressed, and in the second press step, the positive electrode active material layer 120 is located on the surface of the current collector foil 110 in the Z-axis positive direction and pressed. However, the arrangement is not limited to the above. In the first press step, the negative electrode active material layer 130 may be located on the surface of the current collector foil 110 in the Z-axis positive direction and pressed, and in the second press step, the positive electrode active material layer 120 may be located on the surface of the current collector foil 110 in the Z-axis negative direction and pressed.

In the above-described example embodiment, the negative electrode active material layer 130 is pressed first in the first press step, but the positive electrode active material layer 120 may be pressed first in the first press step. That is, the first active material layer may be the positive electrode active material layer 120, and the second active material layer may be the negative electrode active material layer 130. In other words, the first active material layer that is more easily crushed than the second active material layer may be the positive electrode active material layer 120. The first active material layer having a higher porosity than the second active material layer may be the positive electrode active material layer 120. In the first press step, the first active material layer whose size is smaller than that of the second active material layer when viewed from the stacking direction may be pressed.

In the above-described example embodiment, it has been indicated that all of the electrode units 100 are manufactured by the above method, but one of the electrode units 100 may not be manufactured by the above method. It is sufficient if one or more electrode units 100 of a plurality of electrode units 100 provided in the energy storage apparatus 10 are manufactured by the above method.

In the above-described example embodiment, it has been indicated that the active material layer which is located on the current collector foil 110 in the first press step corresponds to the first active material layer, and the active material layer which is located on the current collector foil 110 in the second press step corresponds to the second active material layer. The active material layer located on the current collector foil 110 in the first press step may be rephrased as a first active material layer, and the active material layer located on the current collector foil 110 in the second press step may be rephrased as a second active material layer. The first active material layer is more easily crushed than the second active material layer.

In the above-described example embodiment, it has been indicated that the surface of the current collector foil 110 on which the first active material layer is located in the first press step corresponds to the first surface, and the surface of the current collector foil 110 on which the second active material layer is located in the second press step corresponds to the second surface. The surface of the current collector foil 110 on which the first active material layer is located in the first press step may be rephrased as a first surface, and the surface of the current collector foil 110 on which the second active material layer is located in the second press step may be rephrased as a second surface. The first surface and the second surface are surfaces of the current collector foil 110, which are perpendicular to the direction in which the plurality of electrode units 100 are stacked (the Z-axis direction) and also opposed to each other. In illustration FIG. 5B, the surface facing the Z-axis negative direction of the current collector foil 110 corresponds to the first surface, and the surface facing the Z-axis positive direction corresponds to the second surface.

In the above-described example embodiment, it has been indicated that the negative electrode active material layer 130 is pressed at the pressure P1 in the first press step as the first active material layer, and the positive electrode active material layer 120 is pressed at the pressure P2 in the second press step as the second active material layer. The pressure P1 may be rephrased as a first pressure P1, and the pressure P2 may be rephrased as a second pressure P2.

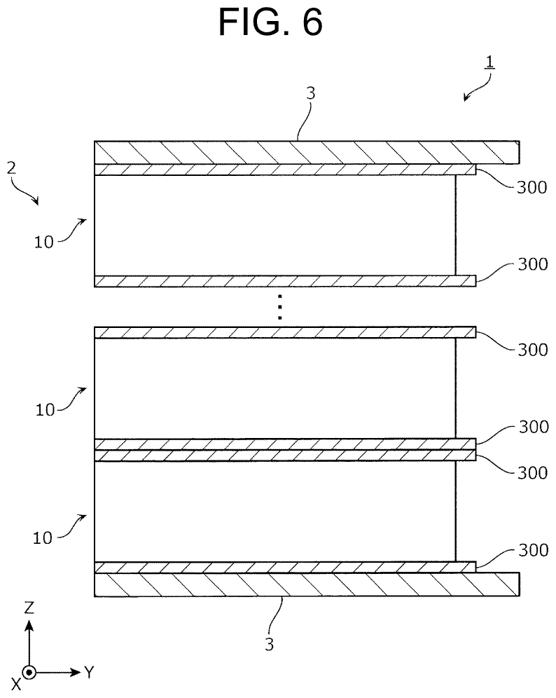

The energy storage apparatus 10 may be used in an energy storage pack 1 as illustrated in FIG. 6. FIG. 6 is a cross-sectional view illustrating a configuration of the energy storage pack 1. In FIG. 6, the internal configuration of the energy storage apparatus 10 is omitted from illustration. As illustrated in FIG. 6, the energy storage pack 1 includes an energy storage apparatus stacking body 2 in which a plurality of energy storage apparatuses 10 are stacked, and a conductive member 3. In this case, it is sufficient if the technique of the present invention is applied to at least one energy storage apparatus 10 included in the energy storage pack 1. Two adjacently located energy storage apparatuses 10 in the energy storage apparatus stacking body 2 are electrically connected to each other by contact or bonding (welding or the like). The conductive member 3 is made of a metal such as stainless steel, and the energy storage apparatus 10 which is located at an end portion in the stacking direction (Z-axis direction) and the conductive member 3 are electrically connected to each other by contact or bonding (welding or the like). An adhesive may be used for the bonding. The plurality of energy storage apparatuses 10 in the energy storage apparatus stacking body 2 are connected in series, and charging and discharging are performed via the conductive member 3. The energy storage pack 1 may be restrained in the stacking direction (the Z-axis direction). In this case, a restraining member such as a screw, a resin band, or a metal band may be used. The energy storage apparatus stacking body 2 and the conductive member 3 may be accommodated in a metal case or a resin case.

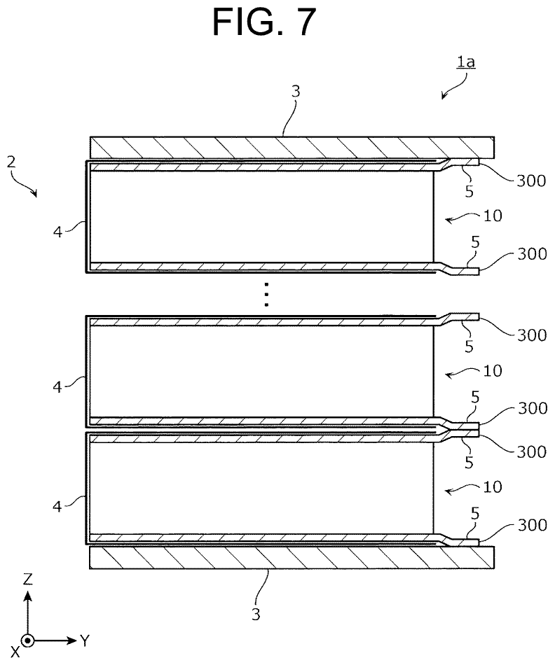

As another example of the energy storage pack 1, FIG. 7 shows a configuration in which each of the energy storage apparatuses 10 is accommodated in an outer package body 4. FIG. 7 is a cross-sectional view illustrating a configuration of an energy storage pack 1a. As illustrated in FIG. 7, the energy storage apparatus 10 of the present structure includes a connection portion 5 exposed from the outer package body 4. A laminate film or the like can be used as the outer package body 4. The connection portions 5 of the adjacently located energy storage apparatuses 10 are electrically connected to each other by contact or bonding (welding or the like). The connection portion 5 of the energy storage apparatus 10 which is located at an end portion in the stacking direction (the Z-axis direction) and the conductive member 3 are electrically connected to each other by contact or bonding (welding or the like). Since the other configurations are the same as those of the energy storage pack 1 described above, description thereof will be omitted.

Example embodiments constructed by arbitrarily combining elements, features, steps, etc., included in the above-described example embodiments and the modification examples thereof are also included in the scope of the present invention.

Example embodiments of the present invention can be applied to, for example, methods of manufacturing energy storage apparatuses such as bipolar batteries.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method of manufacturing an energy storage apparatus including a plurality of electrode units stacked in a stacking direction and each including at least a current collector foil, a positive electrode active material layer on a first surface of the current collector foil, and a negative electrode active material layer on a second surface of the current collector foil, the method comprising:
locating a first active material layer of the positive electrode active material layer and the negative electrode active material layer on the current collector foil and pressing the first active material layer; and
after the locating and pressing the first active material layer, locating a second active material layer of the positive electrode active material layer and the negative electrode active material layer on the current collector foil and pressing the second active material layer together with the first active material layer; wherein
in the locating and pressing the first active material layer, the first active material layer, which is more easily crushed than the second active material layer, is located on the current collector foil, and is pressed at a pressure equal to the pressure at which the second active material layer is pressed, or at a pressure higher than the pressure at which the second active material layer is pressed.

2. The method of manufacturing the energy storage apparatus according to claim 1, wherein in the locating and pressing the first active material layer, the first active material layer having a higher porosity than the second active material layer is located on the current collector foil and pressed.

3. The method of manufacturing the energy storage apparatus according to claim 1, wherein in the locating and pressing the first active material layer, the first active material layer, which is larger in size than the second active material layer when viewed from the stacking direction, is pressed.

4. The method of manufacturing the energy storage apparatus according to claim 1, wherein
in the locating and pressing the first active material layer, the negative electrode active material layer is pressed as the first active material layer; and
in the locating and pressing the second active material layer, the positive electrode active material layer is pressed as the second active material layer.
